(19) United States
(12) Patent Application Publication
(10) Pub. No.: US 2007/0047630 A1
(43) Pub. Date: Mar. 1, 2007

(54) Synchronous control apparatus for initial synchronization when receiving a wireless signal

(75) Inventor: Shigeki Yamauchi, Tokyo (JP)

Correspondence Address: NIXON PEABODY, LLP, 401 9TH STREET, NW, SUITE 900, WASHINGTON, DC, 20004-2128, US

(73) Assignee: Oki Electric Industry Co., Ltd., Tokyo (JP)

(21) Appl. No.: 11/507,494

(22) Filed: Aug. 22, 2006

(30) Foreign Application Priority Data
Aug. 24, 2005 (JP) 2005-241946

(51) Int. Cl. H04B 1/00; H04L 27/06

(52) U.S. Cl. 375/150; 375/343

(57) ABSTRACT

A synchronous control apparatus for reception control in wireless packet communication suppresses detection errors during controlling synchronization to detect codes for improved signal reception. An initial synchronizer includes a code correlator for receiving delayed waves on plural paths. The code correlator outputs a correlation level value through another correlator. The correlation level value is compared with a threshold value from a threshold value register, with the result inputted into an address counter. The correlation level value is also inputted into a correlation level hold circuit. The hold circuit sums the correlation level values obtained in the correlator for a portion of the paths corresponding to a count in the address counter. The hold circuit compares the summed correlation level values with another threshold value from another threshold value register, and uses the result as a basis to set a top timing for receiving delayed waves.

### BACKGROUND OF THE INVENTION

1. Field of the Invention

The present invention relates to a synchronous control apparatus for use in a receiver that receives a wireless signal transmitted in a direct sequence spread spectrum (DSSS) scheme, with accurate initial synchronization established during receiving a wireless signal.

2. Description of the Background Art

Conventionally, for example, Japanese application patent laid-open publication No. 56218/1996 discloses a frame synchronization scheme that reduces, even under a multipath fading environment, a frame timing offset caused by delayed waves to decrease a displacement in frame synchronous position. Japanese application patent laid-open publication No. 178368/1998 discloses a rake combining circuit that receives a plurality of delayed incoming waves, performs an inverse spread spectrum demodulation on the received signals, and combines them with the delay adjusted. U.S. Patent Application Publication No. 2004/0077357 A1 discloses a base station in which a rake receiver applies to a previously received preamble signal path another preamble threshold value to detect that path and in which information on a path exceeding the preamble threshold value is set in the rake receiver to receive a message signal. Japanese application patent laid-open publication No. 2003-298551 discloses a rake receiver that, for a plurality of peaks detected in correlation outputs from digital matched filter (DMF), uses peak value differences as a basis to combine outputs corresponding to the peaks.

For a plurality of delayed waves that are spreading, however, a circuit is needed to improve the received signal-to-noise ratio (SNR). DSSS communication usually uses a correlator or an equalizer to improve the receiving SNR, which may provide a larger circuit for a higher SNR improvement ratio.

DSSS communication may also use a particularly short pseudo noise (PN) code length such as the barker code in IEEE (Institute of Electrical and Electronics Engineers) 802.11b specifications, which may cause detection errors more frequently due to noises or the like.

### SUMMARY OF THE INVENTION

It is an object of present invention to provide a synchronous control apparatus for controlling receiving operation in wireless packet communication with synchronization controlled to detect codes to thereby decrease detection errors and attain accurate signal reception.

The invention provides a synchronous control apparatus for controlling initial synchronization when receiving a wireless signal transmitted in a direct sequence spread spectrum scheme. The apparatus comprises: a correlation value calculator for calculating a correlation level value for each of a plurality of paths of delayed waves; a first comparator for comparing the correlation level values calculated by the correlation value calculator with a first threshold value; a correlation level hold circuit for holding the correlation level values calculated by the correlation value calculator in a descending order of the magnitude of the values; an address counter for counting an address each time the first comparator compares the plurality of paths; and a second comparator for summing the correlation level values for a portion of the plurality of paths corresponding to the address count value, each correlation level value being calculated by the correlation value calculator for one of the plurality of paths. The second comparator compares the summed correlation level values with a second threshold value. The second comparator compares the summed correlation level values for the portion of the plurality of paths with the second threshold value to determine whether or not the plurality of paths of the delayed waves can be repeatedly detected, and uses the comparison result as a basis to set a top timing for receiving the delayed waves.

In accordance with the present invention, the correlation level values for a portion of the plurality of paths corresponding to the address count value are summed, each correlation level value being calculated by the correlation value calculator for one of the plurality of paths. The summed correlation level values are compared with a second threshold value. The summed correlation level values for the portion of the plurality of paths are compared with the second threshold value to determine whether or not the plurality of paths of the delayed waves can be repeatedly detected, and the comparison result is used as a basis to set a top timing for receiving the delayed waves.

DSSS wireless packet communication may thus use a multipath signal and effectively perform an initial synchronization process on a preamble signal, as well as attain a smaller circuit and an improved receiving SNR in its rake receiver. Even when the automatic gain control (AFC) is not in operation as in the initial signal detection or phases vary due to a local signal during transmitting and receiving or a multipath reflection environment, searching for a signal for each multipath may accomplish DSSS wireless packet communication which is insensitive to signal variations not exceeding a predetermined level.

The initial synchronization process using a preamble signal may accomplish smaller correlator and an improved signal-to-noise ratio. A synchronous control apparatus for reception control in wireless packet communication is thus provided which may control synchronization to detect a code with less detection errors to provide excellent signal receipt.

### BRIEF DESCRIPTION OF THE DRAWINGS

The objects and features of the present invention will become more apparent from consideration of the following detailed description taken in conjunction with the accompanying drawings in which:

FIG. 1 is a schematic block diagram illustrating the configuration of an initial synchronizer in an embodiment of a receiver according to the present invention;

FIG. 2 is a schematic block diagram illustrating the configuration of a correlation level hold circuit in the initial synchronizer in FIG. 1;

FIG. 3 is a schematic block diagram illustrating the configuration of a rake receiver in the embodiment of the receiver according to the present invention;

FIG. 4 is a block diagram schematically showing the configuration of the embodiment of the receiver according to the present invention;

FIG. 5 is a flowchart showing a process operation (steps #1 and #2) of the initial synchronizer;

FIG. 6 is a flowchart showing a process operation (stage #3) of the initial synchronizer;

FIG. 7 is another flowchart showing the process operation (stage #3) of the initial synchronizer;

FIG. 8 is a flow chart showing a modified example of the process operation in the initial synchronizer;

FIG. 9 is a schematic block diagram illustrating an example of the internal configuration of a code correlator; and

FIG. 10 is a schematic block diagram illustrating another example of the internal configuration of the code correlator.

### DESCRIPTION OF THE PREFERRED EMBODIMENTS

Referring now to the accompanying drawings, an embodiment of a synchronous control apparatus according to the present invention will be described in detail. With reference to FIG. 4 first, a preferred embodiment of a receiver will be described which uses a synchronous control apparatus according to the present invention.

A receiver 10 receives and demodulates a wireless signal transmitted in the direct sequence spread spectrum (DSSS) scheme. As shown, the receiver 10 includes an initial synchronizer 410 for synchronous control and a rake receiver 420 interconnected as illustrated. The synchronous control portion 410 is connected to receive an in-phase signal 400 and a quadrature signal 402 outputted from a demodulator not-shown to detect a code correlation therebetween to thereby detect an initial signal such as a preamble signal to perform an initial synchronization process. The initial synchronizer 410 outputs the code correlations on its outputs 412 and 414. The initial synchronizer 410 also outputs on its output 416 an enabling signal (EN2) that specifies the most suitable input receiving timing for receiving signals. The outputs 412, 414, and 416 from the initial synchronizer 410 are interconnected to the rake receiver 420. Note that, in the following description, portions that do not directly relate to understanding the present invention will not shown or described. Signals are designated by reference numerals designating connections on which they appear.

The DSSS scheme is a type of transmitting signals spread by applying a sequence of pseudo noise (PN) codes to them. The instant embodiment uses a rake receiving scheme for the DSSS scheme. The rake receiver 420, FIG. 4, is adapted to collect the power of delayed waves to improve the received signal-to-noise ratio (SNR). The rake receiving scheme may effectively be applied to an indoor environment, for example, where the interference between chips, i.e. coding elements of a received signal is influential. Although the illustrated embodiment is directed to the rake receiving scheme, any other schemes such as an equalizer scheme may also be applied.

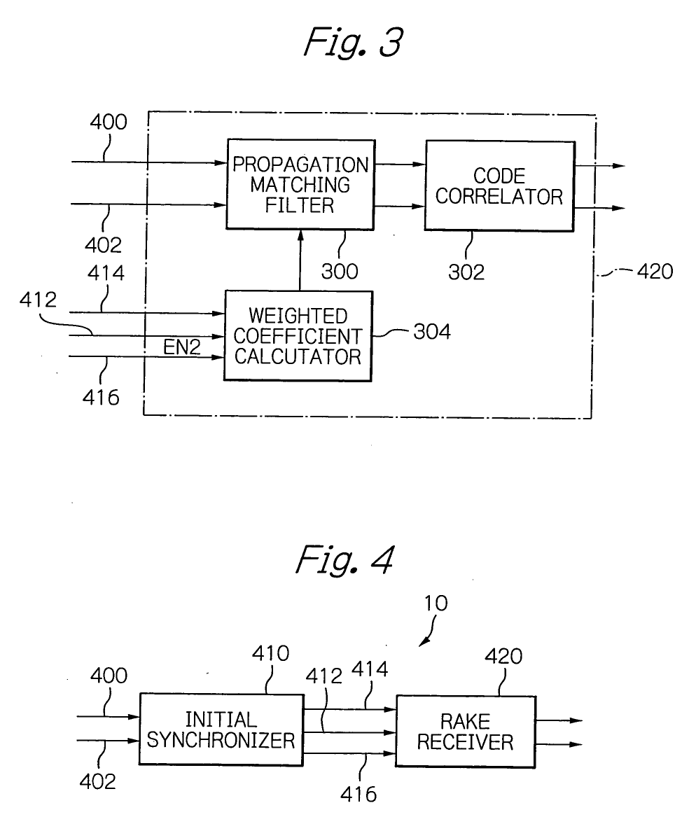

FIG. 3 illustrates an example of the internal configuration of the rake receiver 420. The rake receiver 420 is shown to include a propagation matching filter 300 that is connected to receive on its inputs the in-phase signal 400 and quadrature signal 402, a code correlator 302, and a weighted coefficient calculator 304 that is adapted to determine a weighting coefficient, which are interconnected as illustrated.

In the rake receiver 420, the propagation matching filter 300 may have more taps so as to collect more multipaths, which may effectively obtain the combined energy of delayed waves to further improve the receiving SNR. More taps may, however, provide a larger circuit for the propagation matching filter 300 and a larger circuit for the weighted coefficient calculator 304 that determines the weighting coefficient of the filter 300. Less taps in the propagation matching filter 300 for smaller circuits may largely vary the improvement ratio of the receiving SNR depending on which one of the spreading delayed waves is located at the beginning of the taps. This is true when, for example, the propagation matching filter has a tap length of 270 nsec for the delayed waves of a preamble signal having the IEEE802.11b specifications that are spreading over 500 nsec, where one symbol extends over one microsecond.

This embodiment provides an excellent reception control when processing using the window width corresponding to the tap length of the propagation matching filter 300, by effectively controlling an initial synchronization that determines a timing at which the receiving SNR is maximum. In this case, such an initial synchronization process is performed that a synchronous error caused by noise or like is suppressed.

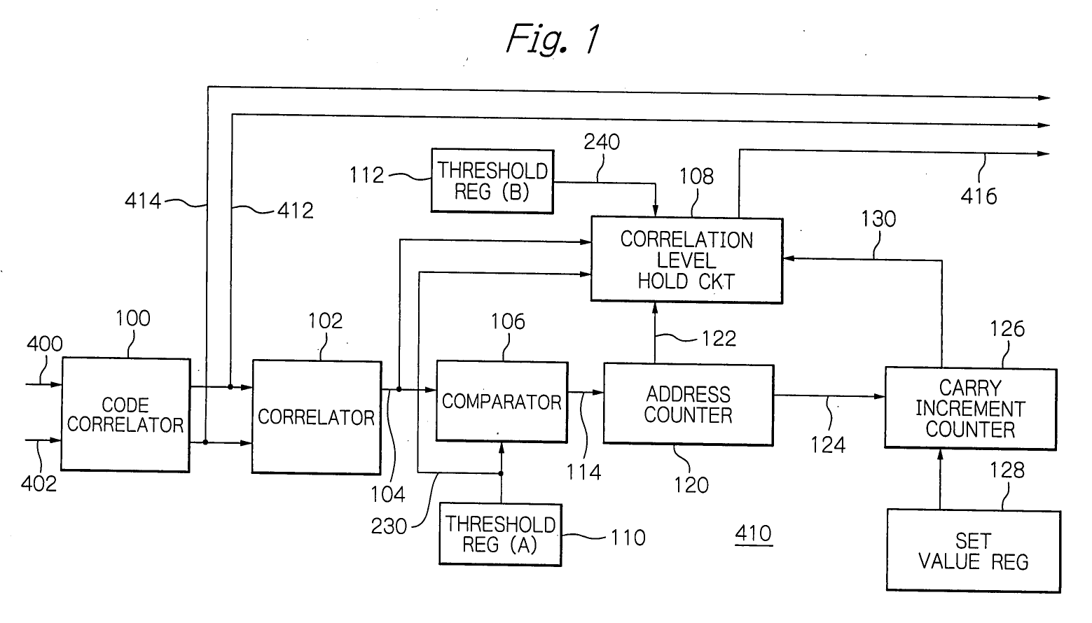

Now, reference will be made to FIG. 1, which illustrates an exemplified internal configuration of the initial synchronizer 410 shown in FIG. 4. The initial synchronizer 410 is adapted to receive on its inputs the in-phase signal 400 and quadrature signal 402 to detect an intended signal and to inform the rake receiver 420 of the beginning position information necessary for the rake receiving process.

The initial synchronizer 410 is shown to include a code correlator 100, a correlator 102, and a comparator 106 and a correlation level hold circuit 108 that is connected to an output 104 of the correlator 102. The code correlator 100 is adapted to calculate the code correlations of the in-phase signal 400 and quadrature signal 402. The correlator 102 is adapted to calculate a correlation level value,(I\hat{0}2+Q\hat{0}2)^{1/2} from the outputs 412 and 414 of the code correlator 100. To each of the comparator 106 and correlation level hold circuit 108, a threshold value register 110 is connected which functions as holding a threshold value A. To the correlation level hold circuit 108, another threshold value register 112 is connected which functions as holding another threshold value B.

The comparator 106 serves as comparing the correlation level value output 104 from the correlator 102 with the threshold value A. The comparator 106 outputs a comparison result in the form of enabling signal (EN) 114 to an address counter 120.

The address counter 120 is adapted to count the enabling signal 114 to output an address count 122 to the correlation level hold circuit 108. The address counter 120 also outputs a carry 124, when generated, to a carry increment counter 126. The carry increment counter 126 is adapted for counting the carry 124. The carry increment counter 126 outputs a significant or truth signal (“1”) 130 to the correlation level hold circuit 108 each time its count reaches a predetermined, set value that is set in a set value register 128. A count held in the carry increment counter 126 allows the path number to be recognized and defines the number of initial synchronization operations.

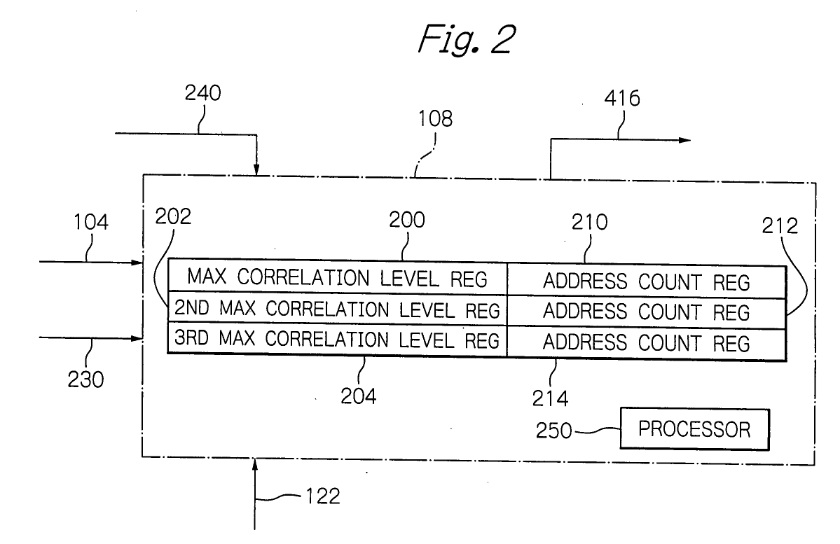

The correlation level hold circuit 108 includes a plurality of registers that are adapted to hold the correlation level values 104 and another plurality of registers that are adapted to hold the address counts 122 to perform an arithmetical operation and comparison on the values held. FIG. 2 illustrates an exemplified internal configuration of the correlation level hold circuit 108. As shown, the correlation level hold circuit 108 in this embodiment includes a maximum correlation level register 200 for holding the maximum correlation level, a second maximum correlation level register 202 for holding the second maximum correlation level value, and a third maximum correlation level register 300 for holding the third maximum correlation level value. The correlation level hold circuit 108 also includes address count registers 210, 212 and 214, which are respectively associated with the registers 200, 202 and 204 to hold respective address counts.

To the correlation level hold circuit 108, connected are the outputs 230 and 240 of the threshold value registers 110 and 112, respectively. The correlation level hold circuit 108 includes a processor 250 that is adapted to be responsive to the threshold values inputted on the inputs 230 and 240 and the correlation level values to perform an arithmetical operation and comparison or like thereon.

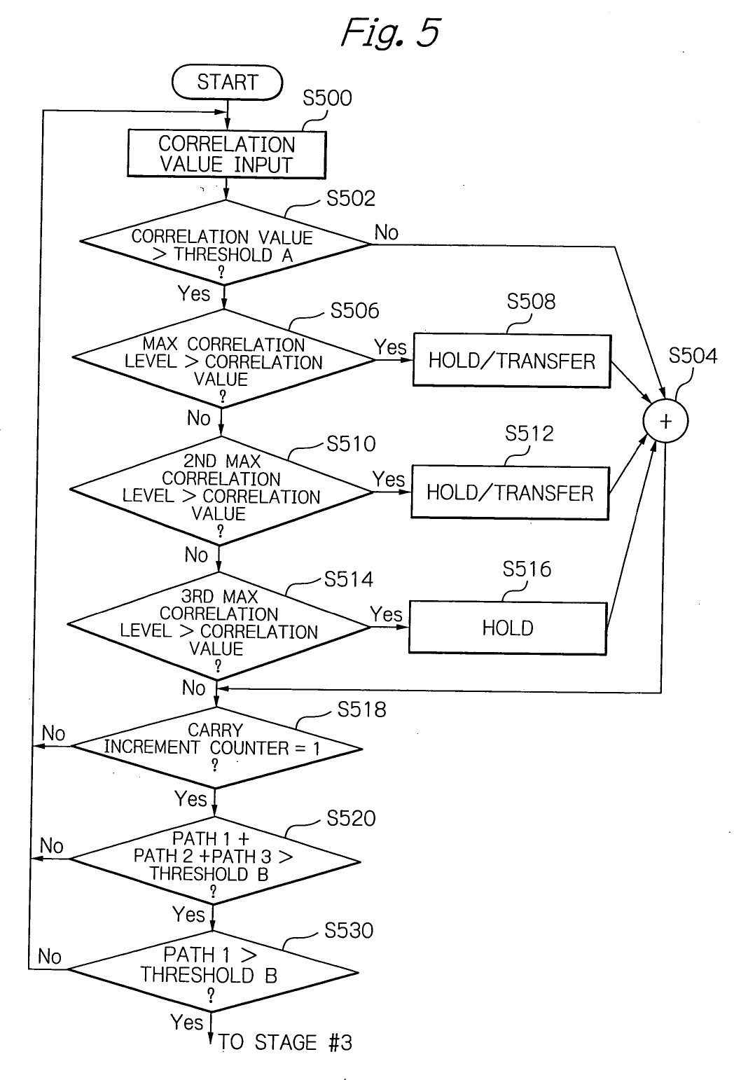

With now referring to FIG. 5 also, a description will be given on the operation of the initial synchronizer 410 in the receiver 10 in the instant embodiment. The initial synchronization process may fall into stages #1, #2 and #3. The stage #3 may further fall into two sub-stages #3-1 and #3-2 when the set value register 128 has its set value of “2”. The two sub-stages #3-1 and #3-2 perform the same process.

The stage #1 determines, for the first path, whether 106 is larger than the threshold value A. Referring to FIG. 5, if the correlation level value is inputted at a step S500, then the process moves to a step S502 which compares the correlation level value with the threshold value A to determine whether or not the correlation level value is larger than the threshold value A.

If the correlation level value is not larger than the threshold value A, then the process moves to a step S504 without holding the relevant correlation level value and address count. If the correlation level value is larger than the threshold value A, then the process moves to the stage #2 starting at a step S506.

The stage #2, starting at the step S506, determines whether or not the maximum correlation level register 200 holds a value smaller than the relevant correlation level value. If the answer is positive, then the process moves to a step S508, and otherwise to a step S510.

At the step S508, the address counter 120 operates in response to the output 114 from the comparator 106, and the correlation level hold circuit 108 holds the relevant correlation level value in the maximum correlation level register 200 and also holds the current address count in the maximum level address count register 210. The correlation level hold circuit 108 transfers the previous maximum correlation level value, if any, held in the maximum correlation level register 200 to the second maximum correlation level register 202, and transfers the previous maximum level address count held in the maximum level address count register 210 to the second maximum level address count register 212. The correlation level hold circuit 108 also transfers the previous second maximum correlation level value, if any, held in the second maximum correlation level register 202 to the third maximum correlation level register 204, and transfers the previous second maximum level address count held in the second maximum level address count register 212 to the third maximum level address count register 214. Note that the maximum value in the address counter 120 is equal to the PN code length of the received preamble signal. Following the above processes is a step S504.

Following the step S506 is a step S510 which determines whether or not the second maximum correlation level register 202 holds a value smaller than the relevant correlation level value. If the answer is positive, then the process moves to a step S512, and otherwise to a step S514.

At the step S512, the address counter 120 operates in response to the output 114 from the comparator 106, and the correlation level hold circuit 108 holds the relevant correlation level value in the second maximum correlation level register 202 and holds the current address count in the second maximum level address count register 212. The correlation level hold circuit 108 transfers the previous second maximum correlation level value, if any, held in the second maximum correlation level register 202 to the third maximum correlation level register 204, and transfers the address count held in the second maximum level address count register 212 to the third maximum level address count register 214. Following the above processes is a step S504.

Following the step S510 is a step S514 which determines whether or not the third maximum correlation level register 204 holds a value smaller than the relevant correlation level value. If the answer is positive, then the process moves to a step S516, and otherwise to a step S518.

At the step S516, the address counter 120 operates in response to the output 114 from the comparator 106, and the correlation level hold circuit 108 holds the relevant correlation level value in the third maximum correlation level register 204 and holds the current address count in the third maximum level address count register 214. Following the above processes is a step S504.

The step S504 sums the correlation value of each path. The process then moves to a step S518. Following the step S504 or S514 is a step S518 which determines whether or not the carry increment counter 126 outputs the significant signal (“1”) 130. If the answer is positive, then the process moves to a step S520, and otherwise the process moves back to the step S500 which continues the above-described processes for the next path.

At the step S520, the processing portion 250 in the correlation level value hold circuit 108 determines whether or not the sum of the correlation value levels of paths 1, 2 and 3 exceeds the threshold value B. If the sum does not exceed the threshold value B, then the process moves back to the step S500, and otherwise to a step S530. At the step S530, the processing portion 250 determines whether or not the correlation value level of the path 1 alone exceeds the threshold value B. If not, then the process moves back to the step S500, and otherwise to the processes at the stage#3. The above-described processes at the steps S506 to S530 form the stage #2.

As described above, the stage #2 confirms the correlation level values for the address counter 120 from “0” to “X”, corresponding to the PN code length, at over-sampling intervals, which may be any of twice, four times, eight times, and so on as short as one chip period of an intended signal, so as to obtain three paths in the descending order of the correlation level values. After obtaining the correlation level value for each position of the path, the process determines, as in the stage #1, whether or not (path 1+path 2+path 3) is larger than the threshold value B. The result may be used to prevent a starting operation caused by detection errors at the stage #1. Because the combined energy of the plurality of delayed waves is used to detect the signals, setting of the threshold value B depending upon the demodulation capability of the rake receiver 420 may prevent the rake receiver 420 from operating at the stage #2. In those processes, if a correlation level value is obtained which is less than or equal to the threshold value, the correlation level value may be handled as “0”.

If the correlation level value for (path 1+path 2+path 3) is determined larger than the threshold value B at the step S520, then the process moves to the stage #3.

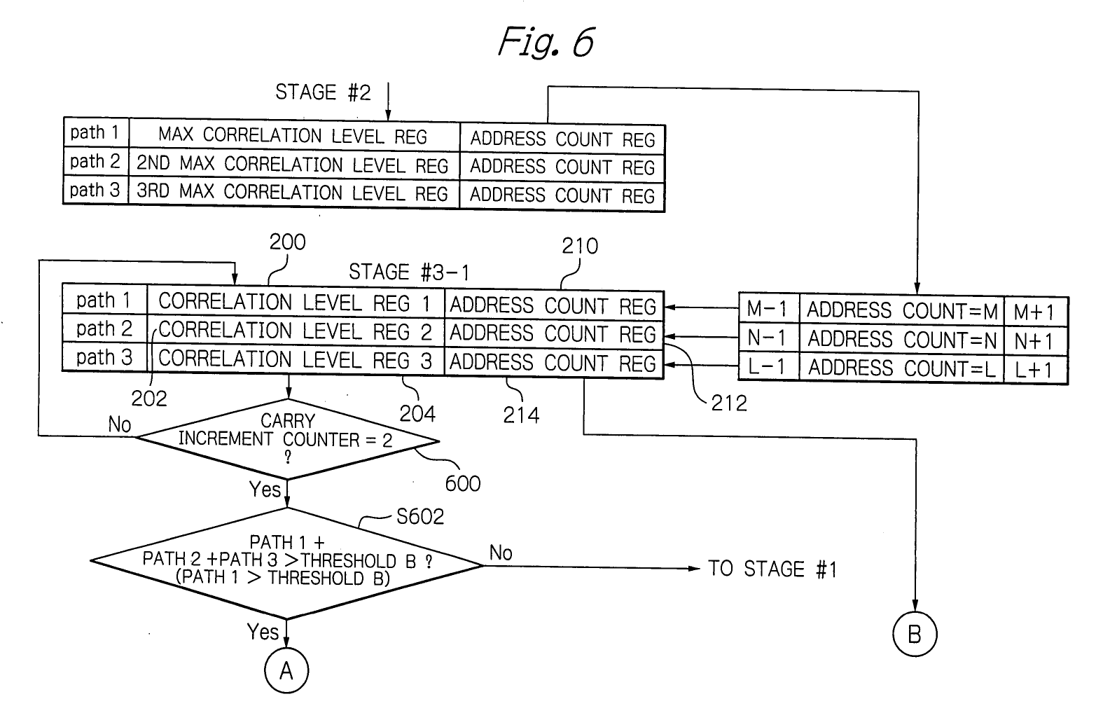

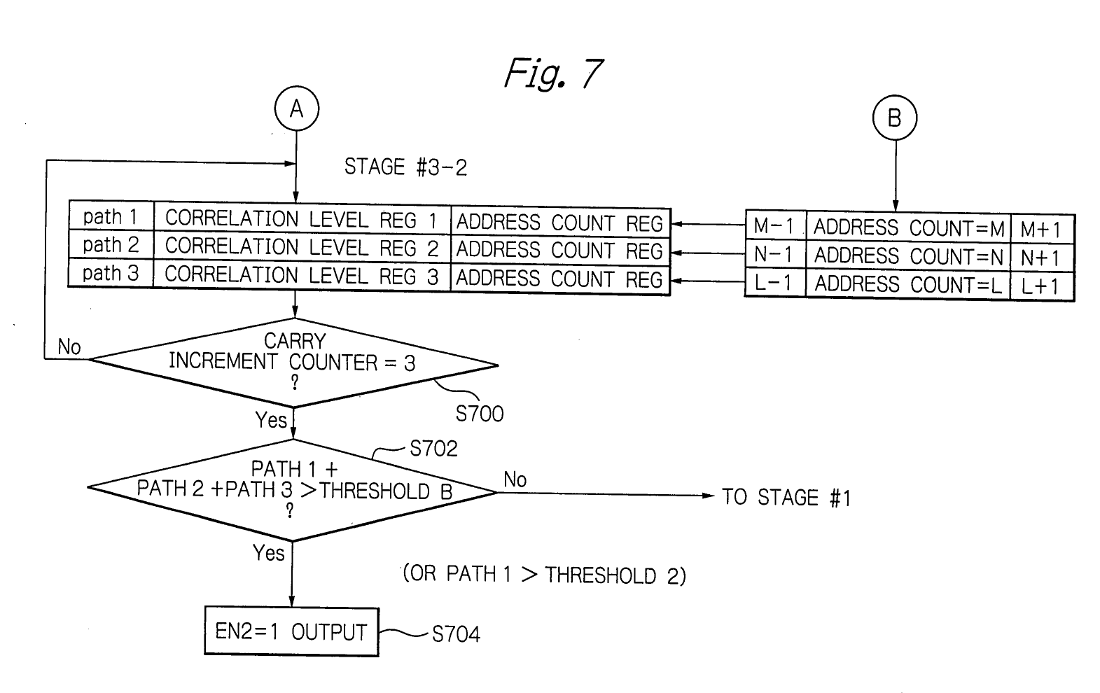

With reference to FIGS. 6 and 7, the operation of the stage #3 will be described in more detail. The stage #3 determines whether or not each delayed wave detected at the stage #2 may be detected repeatedly. Only a value equal to an address count, at which the expected correlation level value is confirmed, plus or minus one is used to check the correlation level value. For example, the maximum correlation level register 200, FIG. 2, holds one of the address counts of M−1, M, and M+1, FIG. 6, which is larger than the threshold value A and is equal to the maximum of those three address counts. Likewise, the second maximum correlation level register 202 holds one of the address counts of N−1, N, and N+1, FIG. 6, which is larger than the threshold value A and is equal to the second maximum of those three address counts. Also, the third maximum correlation level register 204 holds one of the address counts of L−1, L, and L+1, FIG. 6, which is larger than the threshold value A and is equal to the third maximum of those three address counts.

Then a step S600 determines whether or not the carry increment counter 126 equals the set value “2”. If the answer is positive, then the process moves to a step S602, and otherwise the process moves back to the stage #3-1. The step S602 determines whether or not (path 1+path 2+path 3) is larger than the threshold value B. If the answer is positive, then the process moves to a stage #3-2 in FIG. 7, and otherwise the process moves back to the step S500, FIG. 5. When the correlation level value is equal to “0”, the address count may preferably be changed to a value for which the correlation level value is not confirmed.

A step S700 of the stage #3-2 determines whether or not the carry increment counter 126 equals the set value “3”. If the answer is positive, then the process moves to a step S702, and otherwise the process moves back to the stage #3-2. At the step S702, the correlation level hold circuit 108 outputs to the rake receiver 420 a significant (EN2=1) start-up signal for starting up the rake receiver 420 when the condition in which (path 1+path 2+path 3) is larger than the threshold value B is satisfied a number of times equal to the set value (step S704).

As described above, the timing of the top of the taps of the propagation matching filter 300 is determined by using the information in the correlation level registers 200 to 204 at the stage #3-2 and the information in the address count registers 210 to 214. If the second maximum correlation level value has its address count smaller than a count in the maximum correlation level register 200, the second maximum level address count is set as the timing of the top of the taps of the propagation matching filter 300. If the third maximum correlation level value has its address count smaller than a count in the maximum correlation level register 200, the timing of the top of the taps of the propagation matching filter is set depending on the second maximum level address count. Thus, it is determined whether the top timing is set to the third maximum level address count or the maximum level address count.

As described above, the received signal input timing may be set optimal for the rake receiver 420, thereby improving the receiving SNR (signal-to-noise ratio) appropriate for the tap length of the propagation matching filter 300.

DSSS communication has two main propagation characteristics. On is the characteristics in which the maximum level path (primary wave) is followed by the interference waves whose levels decrease in the form of exponential function. The other is the characteristics where multiple paths are established to include signal paths having the signal level thereof almost equal to the primary wave and reaching earlier than the primary wave, such as multiple paths in which the primary wave is not a direct wave but all waves are reflected waves. The illustrative embodiment advantageously improves the receiving SNR particularly for the latter multipath characteristics.

The instant embodiment uses a plurality of delayed waves, and performs signal detection by taking account of a condition where the automatic frequency control (AFC) such as a pseudo DLL (Delay Locked Loop) is not operative and signal detection and determination at a plurality of steps, thereby making it possible to determine signal detection errors in an earlier stage. This is advantageous in, for example, reducing a period of time during which an intended signal could not be acquired due to erroneous detection, thereby improving the overall accuracy in signal detection.

The stage #2 of the above-described embodiment confirms the correlation level value for the address counter 120 from 0 to X, which is equal to the PN code length, at the over-sampling intervals. This means that for the over-sampling interval, which may be twice or four times, for example, as short as the chip period, the correlation level may be confirmed for the same path over four to eight points. For some confirmation timing of the correlation level, therefore, the same signal maybe assigned in the list of the three path information columns.

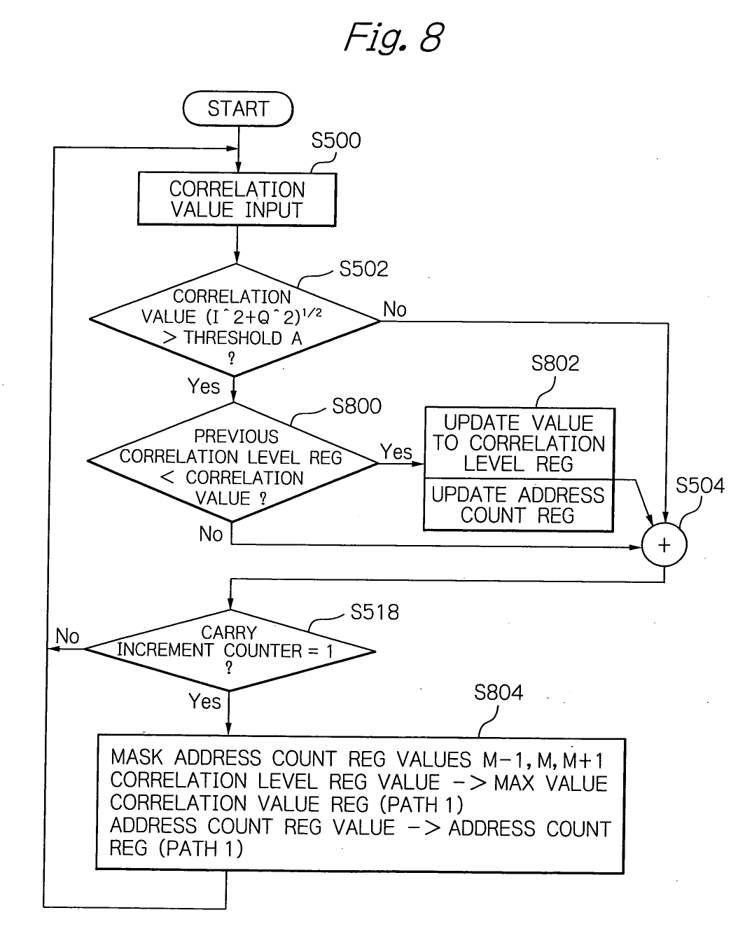

FIG. 8 shows an example of the process to solve the above problem. When information is determined on the path 1, the values M−1, M, and M+1 held in the address count register 210 of the path 1 may be masked (Nulling), and the correlation level value may be confirmed again for the address counter 120 from 0 to X , equal to the PN code length, at the over-sampling intervals (step S804). In this case, the correlation level measurement values are not used for held values M−1, M, and M+1. Note that the step S800, FIG. 8, may be the same as the steps S506, S510 and S514 in FIG. 5, and the step S802, FIG. 8, may be the same as the steps S508, S512 and S515 in FIG. 5.

Likewise, when information is determined on the path 2, the values N−1, N, and N+1 in the address count register 212 of the path 2 may be masked, and the correlation level value maybe confirmed at the same over-sampling intervals as described above. The over-sampling interval twice as short as the chip interval provides the mask points of N−1, N, and N+1. The over-sampling interval four times as short as the chip interval may select the mask points of N−2, N−1, N, N+1, and N+2, or N−1, N, and N+1. The path with the information determined may be subject to the same pseudo DLL process as in the stage #3 described above in connection with FIGS. 6 and 7. This example may advantageously prevent the same path from being assigned in the three path information columns.

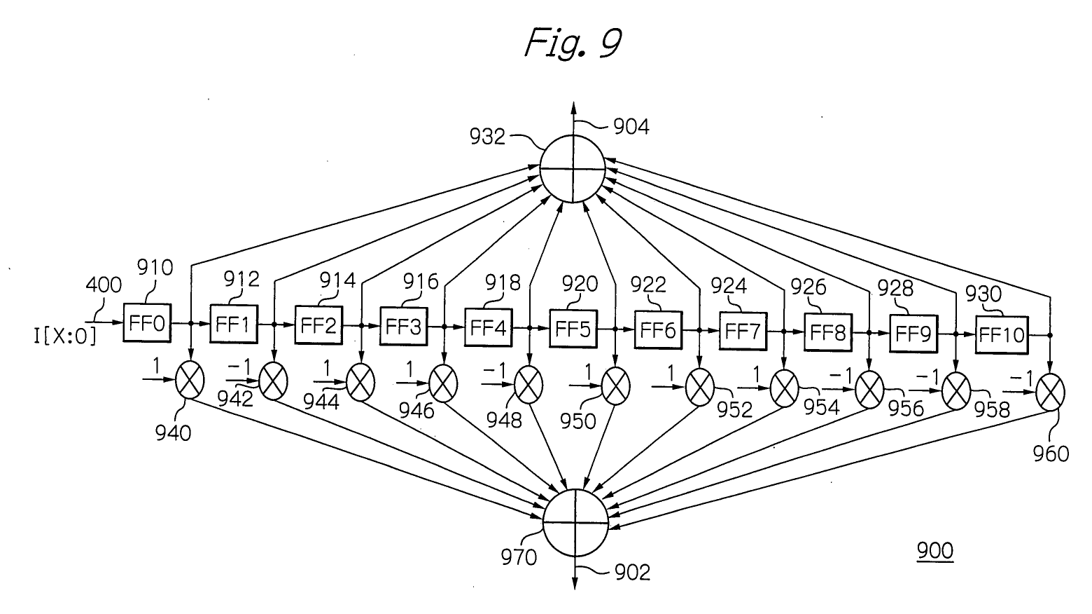

Referring to FIG. 9, an alternative embodiment of the code correlator 100 in FIG. 1 will be described below. In the embodiment in FIG. 1, the code correlator 100 outputs the correlation level values of I and Q on its outputs 412 and 414, respectively. The code correlator 900 in this alternative embodiment in FIG. 9 is adapted to process the I correlation level value 902 and I total power value 904 at the same time to generate the code correlation value. The code correlator 900 shown in FIG. 9 may replace the code correlator 100 shown in FIG. 1.

The code correlator 900 includes a set of flip flops (FF0 to FF10) 910 to 930 connected in series, an adder 932, multipliers 940 to 960, and another adder 970, which are interconnected as illustrated. The set of flip flops 910 to 930 is arranged to sequentially delay the in-phase signal 400 inputted on its input port 400. The adder 932 is adapted for summing the output of each of the flip flops 910 to 930 to produce the I total power value 904. The multipliers 940 to 960 are arranged to multiply the output of each of the flip flops 910 to 930 by a value of 1 and a value of −1, alternately in the arrangement order. The other adder 970 is adapted for summing the output of each of the multipliers 940 to 960 to develop the I correlation level value 902.

When the alternative embodiment of the code correlator 900 is applied, the comparator 106 shown in FIG. 1 is adapted to perform the following processes. The comparator 106 in the alternative embodiment is adapted to determine whether or not the expression (1) is satisfied:
{I (correlation level value)+Q (correlation level value)}/{I (total power value)+Q (total power value)}>threshold value A (1).

Only when the above expression (1) is satisfied, it is determined that there is an intended signal and the process moves to the stage #2, starting at the step S506, in FIG. 5. The expression (1) uses the signal S and noise N to determine the ratio SI (S+N). A set value for the threshold value A may depend upon the demodulation capability of the rake receiver 420. For Eb/N0=0dB, for example, the threshold value is set to 0.5. As described above, unlike the simple comparison of the correlation level value with the threshold value A, the signal is confirmed using the SNR for each path, there by allowing for more accurate signal detection. In that case, unlike the case of a receiver AGC (Automatic Gain Control) block in the receiver or a noise level previously appearing in the code correlator 100, the circuit in the alternative embodiment may measure the SNR in a real-time manner. The process is particularly effective when the receiver AGC cannot follow the signal or has a poor accuracy.

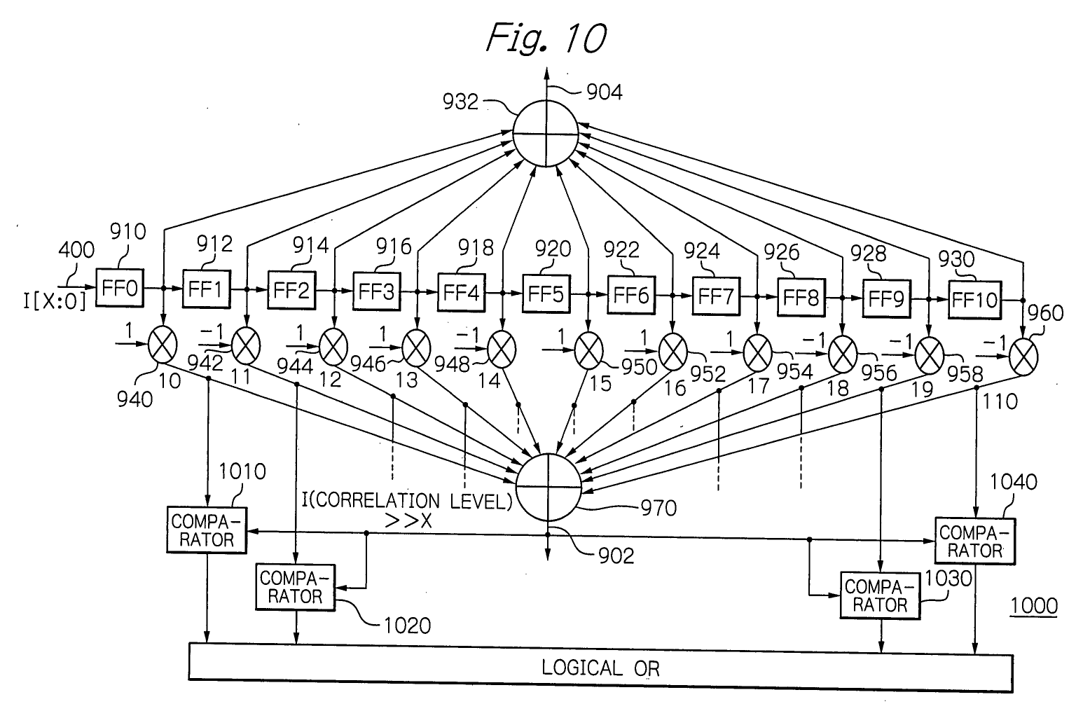

FIG. 10 illustrates another alternative embodiment of the code correlator. The figure shows a configuration concerning the outputting of the I correlation level value. The configuration for outputting the Q correlation level value is not shown but may be the same as what is shown in FIG. 10.

The circuit configuration shown in FIG. 10 additionally includes the circuitry for performing the following process to detect signals more accurately than the embodiment in FIG. 9. A code correlator 1000 in this alternative embodiment includes comparators 1010, 1020, 1030 . . . and 1040 that are adapted to compare the outputs (I0, I1 . . . , I9, and I10) from the multipliers 940, 942 . . . , 958 and 960 with the respective I correlation level values outputted from the adder 970. The comparators 1010 to 1040 have outputs each of which is connected to a logical OR gate 1050.

The correlator 1000 in this alternative embodiment is adapted to determine whether or not the following expression (2) is satisfied:
(I correlation level value/I0)>the threshold value C,
(I correlation level value/I1)>threshold value C . . . and
(I correlation level value/I10)>threshold value C (2).

Even for a multipath or noisy environment condition, the chip energy in the correlation level values detected in an intended signal is not concentrated in some chips but distributed over the entire chips. Thus, as defined by the expression (2), the ratio of the I in-phase correlation value to each I in-phase chip energy, for example, may be confirmed as a correlation level value, thereby further improving the signal detection accuracy.

For example, even when the correlation value level satisfies the above expression (1), the signal is not deemed as an intended signal if the expression (2) is not satisfied due to the chip energy deviation or the like. The embodiment shown in FIG. 10 may thus advantageously suppress the detection errors otherwise caused by the noise or the like likewise the embodiment shown in and described with reference to FIG. 9. The detection process performed by the structure shown in FIG. 10 may further prevent the signal detection errors.

The present invention also provides a synchronous control method for controlling initial synchronization when receiving a wireless signal transmitted in a direct sequence spread spectrum scheme. The method comprises: a correlation value calculation step of calculating a correlation level value for each of a plurality of paths of the delayed waves; a first comparison step of comparing the correlation level value calculated by the correlation value calculator with a first threshold value; a correlation level hold step of holding the correlation level values calculated by the correlation value calculator in a descending order of the magnitude of the values; an address counting step of counting an address each time the first comparator compares the plurality of paths; and a second comparison step of summing the correlation level values for a portion of the plurality of paths corresponding to the address count value, each correlation level value being calculated by the correlation value calculator for each of the plurality of paths. The second comparison step compares the summed correlation level values with a second threshold value. The second comparison step comprises the substeps of comparing the summed correlation level values for the portion of the plurality of paths with the second threshold value to determine whether or not the plurality of paths of the delayed waves can be repeatedly detected, and using the comparison result as a basis to set a top timing for receiving the delayed waves.

In accordance with the invention, the following aspects are provided:

1. A synchronous control method for controlling initial synchronization when receiving a wireless signal transmitted in a direct sequence spread spectrum scheme, comprising:

a correlation value calculation step of calculating a correlation level value for each of a plurality of paths of delayed waves;

a first comparison step of comparing the correlation level value calculated by said correlation value calculation step with a first threshold value;

a correlation level hold step of holding the correlation level values calculated by said correlation value calculation step in a descending order of a magnitude of the values;

an address counting step of counting an address each time the plurality of paths are compared in said first comparison step; and

a second comparison step of summing the correlation level values for a portion of the plurality of paths corresponding to the address count value, each correlation level value being calculated by said correlation value calculating step for one of the plurality of paths, said second comparison step comparing the summed correlation level values with a second threshold value;

said second comparison step comprising the substeps of comparing the summed correlation level values for the portion of the plurality of paths with the second threshold value to determine whether or not the plurality of paths of the delayed waves can be repeatedly detected, and using the comparison result as a basis to set a top timing for receiving the delayed waves.

2. The method in accordance with aspect 1, wherein said correlation value calculating step comprises the substep of calculating the correlation level value from an preamble signal of the plurality of paths of the delayed waves.

3. The method in accordance with aspect 1, wherein said first comparison step comprises the substeps of measuring the correlation level value and a present total level value at a same time to calculate a signal-to-noise ratio, and comparing the signal-to-noise ratio with the first threshold value to determine whether or not an intended signal exists.

4. The method in accordance with aspect 1, wherein said first comparison step comprising the substeps of calculating a ratio of the correlation level value to present chip energy, and comparing the ratio with a third threshold value to determine whether or not an intended signal exists.

5. The method in accordance with aspect 1, further comprising a receiving step of receiving and demodulating the plurality of paths of the delayed waves, said receiving step receiving the plurality of paths of the delayed waves according to the top timing set in said second comparison step.

6. The method in accordance with aspect 1, wherein said second comparison step comprising the substep of performing a pseudo DLL (Delay-locked Loop) process on each of the delayed waves to determine whether or not the plurality of paths of the delayed waves can be repeatedly detected.

The entire disclosure of Japanese patent application No. 241946/2005 filed on Aug. 24, 2005, including the specification, claims, accompanying drawings and abstract of disclosure is incorporated herein by reference in its entirety.

While the present invention has been described with reference to the particular illustrative embodiments, it is not to be restricted by the embodiments. It is to be appreciated that those skilled in the art can change or modify the embodiments without departing from the scope and spirit of the present invention.

What is claimed is:

1. A synchronous control apparatus fort controlling initial synchronization when receiving a wireless signal transmitted in a direct sequence spread spectrum scheme, comprising:
a correlation value calculator for calculating a correlation level value for each of a plurality of paths of delayed waves;
a first comparator for comparing the correlation level values calculated by said correlation value calculator with a first threshold value;
a correlation level hold circuit for holding the correlation level values calculated by said correlation value calculator in a descending order of a magnitude of the values;
an address counter for counting an address each time said first comparator compares the plurality of paths; and
a second comparator for summing the correlation level values for a portion of the plurality of paths corresponding to the address count value, each correlation level value being calculated by said correlation value calculator for one of the plurality of paths, and for comparing the summed correlation level values with a second threshold value;
said second comparator comparing the summed correlation level values for the portion of the plurality of paths with the second threshold value to determine whether or not the plurality of paths of the delayed waves can be repeatedly detected, and using the comparison result as a basis to set a top timing for receiving the delayed waves.

2. The apparatus in accordance with claim 1, wherein said correlation value calculator calculates the correlation level value from an preamble signal of the plurality of paths of the delayed waves.

3. The apparatus in accordance with claim 1, wherein said first comparator measures the correlation level value and a present total level value at a same time to calculate a signal-to-noise ratio, and compares the signal-to-noise ratio with the first threshold value to determine whether or not an intended signal exists.

4. The apparatus in accordance with claim 1, wherein said first comparator calculates a ratio of the correlation level value to present chip energy, and compares the ratio with a third threshold value to determine whether or not an intended signal exists.

5. The apparatus in accordance with claim 1, further comprising a receiver interconnected to an output of said second comparator for receiving and demodulating the plurality of paths of the delayed waves, said receiver receiving the plurality of paths of the delayed waves according to the top timing set by said second comparator.

6. The apparatus in accordance with claim 5, wherein said receiver is a rake receiver.

7. The apparatus in accordance with claim 1, wherein said second comparator performs a pseudo DLL (Delay-Locked Loop) process on each of the delayed waves to determine whether or not the plurality of paths of the delayed waves can be repeatedly detected.
